(19) United States
(12) Patent Application Publication
(10) Pub. No.: US 2026/0205795 A1
(43) Pub. Date: Jul. 16, 2026

(54) SYSTEMS AND METHODS FOR SHARING SERVICES ACROSS USER EQUIPMENTS

(71) Applicant: Verizon Patent and Licensing Inc., Basking Ridge, NJ (US)

(72) Inventors: Jyotsna KACHROO, Millburn, NJ (US); Matthew Scott DEATRICK, Oak Ridge, NJ (US); Sudhakar Reddy PATIL, Flower Mound, TX (US); Shanthala KURAVANGI-THAMMAIAH, Keller, TX (US); Yuk Lun LI, Morganville, NJ (US)

(73) Assignee: Verizon Patent and Licensing Inc., Basking Ridge, NJ (US)

(21) Appl. No.: 19/018,284

(22) Filed: Jan. 13, 2025

(51) Int. Cl. H04W 8/18; H04M 15/00; H04W 48/08

(52) U.S. Cl. CPC H04W 8/18; H04M 15/885; H04W 48/08

(57) ABSTRACT

In some implementations, a device may receive a request to share a service associated with a subscription, wherein the subscription is associated with a first user equipment (UE), and the request is for the service to be shared with a second UE that is not associated with the subscription. The device may provide the service to the second UE based on the request.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with sharing services across user equipments (UEs).

FIG. 2 is a diagram of an example associated with sharing services across UEs.

FIG. 3 is a diagram of an example environment in which systems and/or methods described herein may be implemented.

FIG. 4 is a diagram of example components of one or more devices of FIG. 3.

FIG. 5 is a flowchart of an example process associated with sharing services across UEs.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) may have a subscription with a service provider, which may allow the UE to access a service via the service provider. The service may include a content service, such as a video streaming service or a gaming service. The subscription may be associated with a subscription profile, which may define different services that are accessible to the UE based on the subscription. Certain subscriptions (e.g., subscription levels) may enable the UE to access more services, while certain subscriptions may enable the UE to access fewer services in relation to other types of subscriptions. In some cases, the subscription may be managed to add additional services and/or to remove services. The service may be provided directly by a service provider, such as a telecommunications provider, broadband provider, content provider, etc. For example, the telecommunications provider may provide a variety of movies, television programs, and/or games to the UE based on the subscription. Alternatively, the service may be provided by a content provider via the telecommunications provider. For example, the content provider may offer a variety of movies, television programs, and/or games, depending on the subscription, which may be delivered to the UE via the telecommunications provider.

In one example, the UE with the subscription may be able to access the service, but another UE that is outside of the subscription may be unable to access the service. For example, multiple UEs that are associated with the same subscription (e.g., same account) may all have access to the service, but another UE that is outside of the multiple UEs may not have access to the service. In some cases, a user associated with the UE with the subscription may want to share the service associated with the subscription to a friend or family member associated with the other UE that is outside of the subscription. However, the UE may not be configured to share the service associated with the subscription to the other UE that is outside of the subscription. As a result, the other UE may need to separately subscribe to the telecommunications provider, and the telecommunications provider may need to configure the other UE to be able to access the service, which may expend additional resources at the other UE and/or at a telecommunications network associated with the telecommunications provider, thereby degrading an overall system performance.

In some implementations, services may be shared among different UEs. A first UE may be associated with a subscription, which may allow access to one or more services (e.g., content delivery services). In some cases, a first user associated with the first UE may share an access to a service, of the one or more services, to a second user associated with the second UE for a limited duration of time. The second user may be indicated on a contact list that is maintained by the first UE and a device in a telecommunications network. In order for the service to be shared, the device may identify a primary key associated with the first UE, and then the device may generate a secondary key based on the primary key. The second UE may be provided with the secondary key. The second UE may also be provided with a profile, which may define a specific service that is able to be accessed by the second UE. When the second UE attempts to access the service in accordance with the profile, the second UE may provide the secondary key. After a verification of the secondary key provided by the second UE, the second UE may be allowed to access the service shared by the first UE. As a result, the first UE may be able to share access to the service to the second user that is included on the contact list. The first UE may be able to share access to the service even though the second UE is not associated with the subscription. In other words, the subscription may not include the second UE, but the first UE may be able to share access to the second UE for the limited duration of time.

In some implementations, by creating the profile that defines the service that is able to be accessed by the second UE and the secondary key that allows the second UE to access the service, the service may be shared by the first UE to the second UE, even though the second UE may not be associated with the subscription that involves the service. The second UE may not separately need to sign up for the subscription to the service, but rather may be able to use the first UE’s access to the service for the limited duration of time. As a result, the second UE may not need to separately subscribe to the service and instead utilize the first UE’s subscription, which may save resources at the second UE and/or at a telecommunications network, thereby improving an overall system performance.

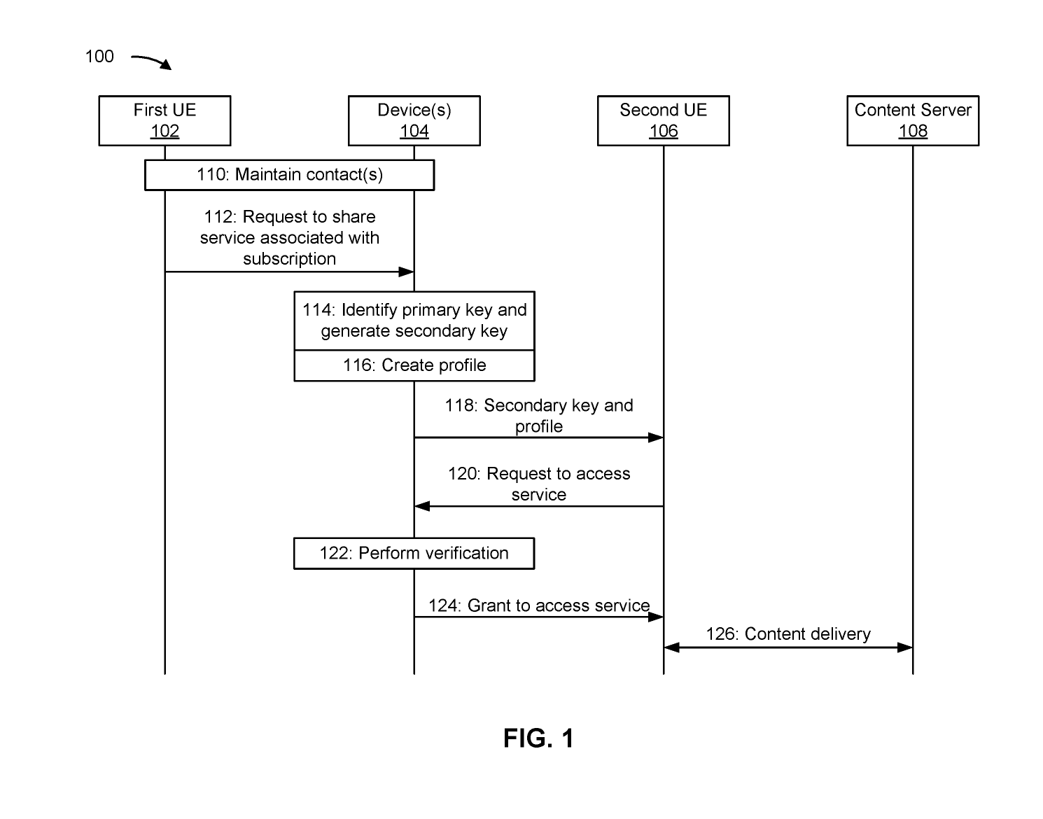

FIG. 1 is a diagram of an example 100 associated with sharing services across UEs. As shown in FIG. 1, example 100 includes a first UE 102, one or more devices 104, a second UE 106, and a content server 108. The first UE 102 may be a primary UE. The one or more devices 104 may be associated with a base station in a radio access network (RAN), an access and mobility management function (AMF), an authentication server function (AUSF), a unified data management (UDM), an authentication and key management for applications (AKKA) anchor function (AAnF), a network exposure function (NEF), an application function (AF), a contacts manager, and/or a profile manager such as a subscriber identification module (SIM) profile manager. The second UE 106 may be a companion UE.

As shown by reference number 110, the first UE 102 and/or a device 104, of the one or more devices 104, may maintain a contact list of a first user associated with the first UE 102. In this example, the device 104 may be associated with the contacts manager. The contact list may contain a plurality of contacts associated with the first user. The contact list may include family members, friends, acquaintances, service providers, and/or other persons associated with the first user. The first UE 102 may create and update the contact list, where the contact list may be stored locally at the first UE 102 and the contact list may be stored by the device 104. Any changes made to the contact list on the first UE 102 may be reflected on the contact list maintained by the device 104. The first UE 102 may run a cloud contact application that allows the changes to be made to the contact list, which may then be reflected on the contact list maintained by the device 104.

In some implementations, the first user associated with the first UE 102 may subscribe to a subscription. The subscription may be for a content delivery service. For example, the subscription may be for a video streaming service, a gaming service, a music streaming service, and/or any other suitable type of service. The subscription may allow the first UE to stream video (e.g., movies and television programs), play electronic games, stream music, and so on. In some cases, the subscription may be for a non-content-delivery service. For example, the subscription may be for a cloud storage service, where the subscription may allow the first UE to access cloud storage. The subscription may be limited to the first UE 102 and any other UE that is part of a same account (e.g., UEs in the same household may all have access to the subscription).

In some implementations, the first user associated with the first UE 102 may share a service associated with the subscription on a limited basis with a second user associated with the second UE 106, such as a friend or a family member. For example, the first user may share the service with the second user for a limited period of time so that the second UE is able to access the service. For example, access to the service may allow the second user to watch a certain movie via the second UE 106. After the movie is watched, the service may no longer be shared with the second UE 106. The second user may not be associated with the subscription. In other words, the second user may not be on the same account, which would typically prevent the second user from having access to the service. The first UE 102 and the second UE 104 may be associated with a same service provider. Alternatively, first UE 102 and the second UE 104 may be associated with different service providers.

As shown by reference number 112, the first UE 102 may transmit, to the device 104, a request to share the service associated with the subscription. The request may be to share the service with the second UE 106 that is not associated with the subscription. The service may be one of a plurality of services associated with the subscription, where not all services in the plurality of services are shared with the second UE 106 in accordance with the request. In other words, the first user may select which particular service is to be shared with the second UE 106, and only that particular service may be indicated in the request. The request may indicate a contact number (e.g., phone number) associated with the second UE 106. The contact number may be on the contact list that is maintained by the first UE 102 and the device 104. In other words, the request may be to share the service with one of the contacts (e.g., the second user) on the contact list associated with the first UE 102. The service may be shared with the second user based on an inclusion of the contact (e.g., the second user) on the contact list. In some implementations, when the request indicates a contact number that is not on the contact list that is maintained by the first UE 102 and the device 104, the request may be invalid. In other words, only contacts that are included on the contact list may be able to access the service shared by the first UE 102. The first UE 102 may provide the contact list along with the request, or alternatively, the device 104 may already maintain the contact list and the contact list may not be sent by the first UE 102.

As shown by reference number 114, the device 104 may identify a primary key associated with the first UE 102 and/or the subscription. The primary key may be an AKMA key. The device 104 may generate a secondary key in response to the request. In this example, the device 104 may be associated with the AUSF and/or the AAnF. The device 104 may generate the secondary key based on the primary key. For example, the secondary key may be a derivative of the primary key. The secondary key may be associated with a limited functionality in relation to the primary key. For example, the secondary key may be generated from the primary key, but another key may not be generated from the secondary key. The device 104 may store the primary key and the secondary key.

In some implementations, the primary key may be a credential key that is tied to a subscription identifier (e.g., the primary key may be tied to the subscriber, such as the first user). The primary key may be based on a SIM based keying mechanism. The SIM based keying mechanism may involve AKMA and/or Extensible Authentication Protocol (EAP) key credential management. AKMA may provide authentication and key management based on subscription credentials for mobile subscriber implicit authentication in applications. AKMA may rely on a primary authentication successful result for generating AKMA keys and authenticating mobile subscribers in applications. AKMA may be a network based via control plane silent authentication mechanism that does not rely on third party proxy or authentication entities. By using the primary key (e.g., AKMA key), uniquely derived secondary keys may be created for each contact (or user) for whom the service is shared. The secondary keys may be created for each contact field selected for service sharing. Secondary keys for various family members and/or friends may be created. A wireless key management infrastructure to authenticate and validate the secondary keys. The secondary keys may have limited functionality and cannot be used to create and/or manage keys. A key management capability may remain with a primary key user or subscriber, such as the first user associated with the first UE 102.

In some implementations, when the UE is AKMA enabled, the UDM may store an AKMA indicator in subscription data associated with the first UE 102. The AUSF may generate the primary key, such as an AKMA anchor key, from a root session key (KAUSF). The KAUSF may be stored by the AUSF. The AUSF may provide the AKMA anchor key to the AAnF. The AAnF may store the AKMA anchor key for an AKMA service. In some implementations, after the first user signs up for a cloud contact feature, the primary key leveraging K-AKMA (e.g., an AKMA specific key) may be associated with the first user and/or the first UE 102. Key derivations off of the primary key may be used for creating the secondary keys (e.g., shared keys and limited keys). Each contact on the contact list may then be associated with the secondary key, where the secondary key may be associated with an application identifier (K-AKMA key) and a contact identifier K-AKMA derived key (e.g., K-AKMA Contact 1). The AAnF may be used to authenticate a subscription status when the second UE 106 attempts to access the service.

As shown by reference number 116, the device 104 may create, in response to the request, a profile for the second UE 106. In this example, the device 104 may be the SIM profile manager. The profile may indicate that the second UE 106 is allowed to access the service. In other words, the profile may indicate which specific services are shared with the second UE 106. The profile may indicate a time period for which the second UE 106 is able to access the service. The device 104 may create the profile based on a SIM (or embedded SIM) profile management. The profile may be specific to the second UE 106 and may not be applicable to other UEs.

As shown by reference number 118, the device 104 may provide the secondary key and the profile to the second UE 106, where access to the service may be based on the secondary key and the profile. The second UE 106 may download the profile to enable a seamless login and UE authentication to the service. Access to content services for authenticated users may be based on the profile. In other words, by indicating the secondary key and the profile to the second UE 106, the device 104 may notify the second UE 106 that the first UE 102 has shared the service with the second UE 106. The second UE 106 may accept or opt in to be able to access the service shared by the first UE 102. The second UE 106 may include an embedded universal integrated circuit card (eUICC), which is a component of a SIM card that is a part of the second UE 106. The eUICC may store the profile on the second UE 106 and allow the second UE 106 to access the service.

As shown by reference number 120, when the second UE 106 is ready to access the service, the second UE 106 may transmit, to the device 104, a request to access the service associated with the subscription. The second UE 106 may transmit the request in accordance with the profile. For example, the second UE 106 may transmit the request for the specific service that is indicated in the profile as being accessible to the second UE 106. The request may indicate the secondary key, which may provide proof that the second UE 106 is indeed authorized to access the service.

As shown by reference number 122, the device 104 may perform a verification of the request. The device 104 may verify that the secondary key indicated in the request to access the service corresponds to the secondary key that was generated based on the primary key. In other words, the device 104 may compare the secondary key that is already stored with the secondary key that is indicated by the second UE 106. When the secondary key that is already stored matches with the secondary key indicated by the second UE 106, and when the request is for a service that is allowed to be accessed in accordance with the profile, the device 104 may verify that the request is valid.

As shown by reference number 124, the device 104 may transmit, to the second UE 106, an indication that access to the service is granted. The device 104 may provide access to the service to the second UE 106 based on the request to share the service from the first UE 102 and the request to access the service from the second UE 106. In other words, the device 104 may grant the second UE 106 access to the service based on the verification.

As shown by reference number 126, the second UE 106 may communicate with the content server 108 in order to access the service. For example, the second UE 106 may transmit a request to the content server 108. The request may include the indication from the device 104 that access to the service is granted. The content server 108, after receiving the request, may provide content to the second UE 106, where the content may be associated with the service, and where the service may be associated with the subscription held by the first UE 102. As a result, the second UE 106 may be able to access the service that is shared by the first UE 102. The second UE 106 may be able to access the service for the limited duration of time, and/or until the first UE 102 indicates that the access to the service should be stopped. The second UE 106 may be able to access the service even though the second UE 106 is not associated with the subscription held by the first UE 102. Content delivery by the content server 108 may be based on an application programming interface (API) layer to a third party subscription provider, which may be associated with the content server 108. In some implementations, the content delivery may be based on a standard security process. Alternatively, the content delivery may be based on one or more layers of security added to the standard security process.

In some implementations, a standalone network architecture may be associated with a service management for subscribers. The standalone network architecture may provide a foundation for a services based experience. The standalone network architecture may provide an ability to provide appropriate network and service resources. Application data provided via the standalone network architecture may receive appropriate treatment depending on application needs and/or user profiles. By utilizing the standalone network architecture, wireless subscribers may be able to share movies and/or games associated with their subscription profile to cloud contacts. For example, the wireless subscribers may share their access to services with friends and family, which may allow the wireless subscribers from one telecommunications network to share a service offering to users in another telecommunications network. The standalone network architecture may be used to provide features across UEs (e.g., across primary and companion devices, such as the first UE 102 and the second UE 106, respectively). The standalone network architecture may utilize key management, eSIM and SIM technologies, and/or network slicing for isolation and management of services, which may enable the features to be shared across the UEs.

In some implementations, in a fixed wireless access (FWA) use case, a router may be employed as an authentication proxy (AP). An identify (K-AKMA proxy) server proxy may be added to the router for in-home management of service sharing. The router may maintain a local copy of the contact list. When the second UE 106 associated with the contact number that is on the contact list connects to the router, the router may authorize the second UE 106 and provide access the second UE 106 with access to the service. For example, the second user associated with the second UE 106 may walk into the primary subscriber’s home, the second UE 106 may connect to the router, and then the router may provide access to the service to the second UE 106 based on an inclusion of the contact number associated with the second UE 106 on the contact list. In this example, the router may receive the secondary key from the device 104, and when the second UE 106 connects to the router, the router may transmit a request to access the service along with the secondary key to the device 104. The device 104 may approve the request, which may allow the router to access content from the content server 108, which may then be relayed to the second UE 106.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

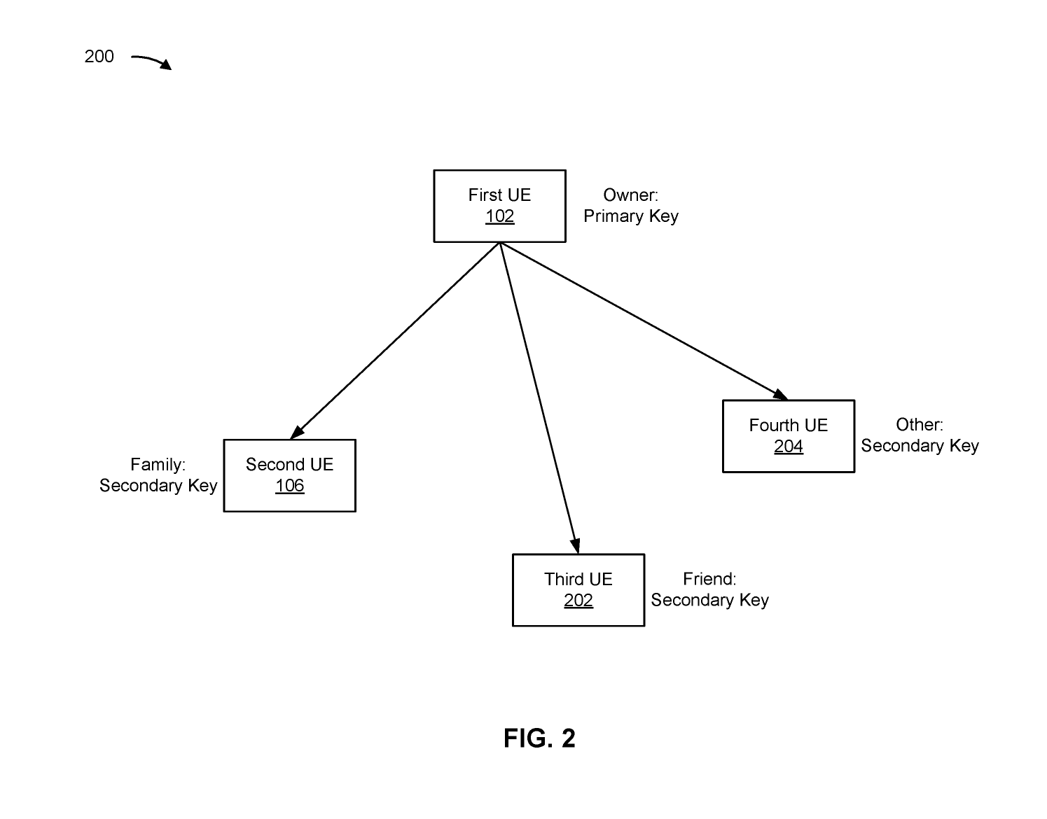

FIG. 2 is a diagram of an example 200 associated with sharing services across UEs. As shown in FIG. 2, example 200 includes a first UE 102, a second UE 106, a third UE 202, and a fourth UE 204.

In some implementations, the first UE 102 may be associated with a primary key. The first UE 102 may be able to access a service associated with a subscription. The first UE 102 may subscribe to the subscription. The subscription may be for a content delivery service. For example, the subscription may be for a video streaming service, a gaming service, a music streaming service, and/or any other suitable type of service. The primary key may be used to generate one or more secondary keys. Each secondary key may be derived from the primary key. Different secondary keys may become associated with different other UEs. For example, a first secondary key may be associated with the second UE 106, a second secondary key may be associated with the third UE 202, and a third secondary key may be associated with the fourth UE 204. The first UE 102 may be associated with a first user (e.g., an owner of the subscription). The second UE 106, the third UE 202, and the fourth UE 204 may be associated with family members, friends, and/or other persons associated with the first user. The second UE 106, the third UE 202, and the fourth UE 204 may use respective secondary keys when accessing the service associated with the subscription.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

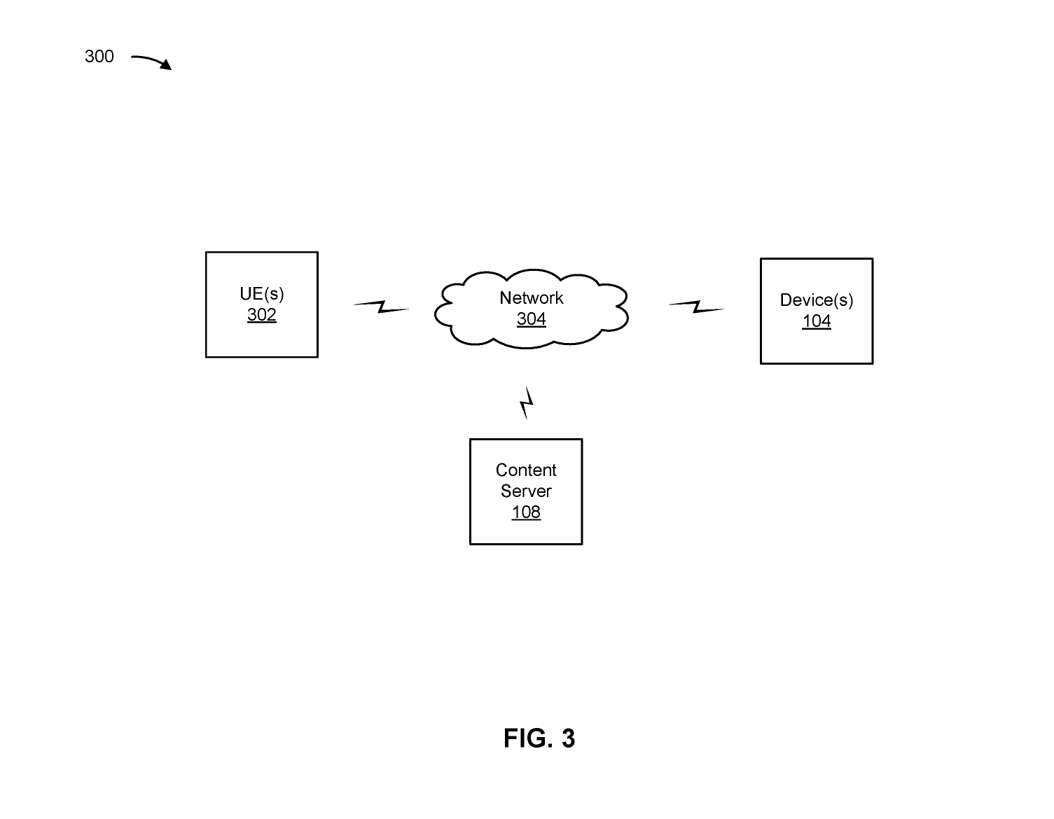

FIG. 3 is a diagram of an example environment 300 in which systems and/or methods described herein may be implemented. As shown in FIG. 3, environment 300 may include one or more UEs 302, which may include a first UE 102 and a second UE 106, one or more devices 104, a content server 108, and a network 304. Devices of environment 300 may interconnect via wired connections, wireless connections, or a combination of wired and wireless connections.

A UE 302 may include one or more devices capable of receiving, generating, storing, processing, and/or providing information associated with sharing services across UEs, as described elsewhere herein. The UE 302 may include a communication device and/or a computing device. For example, the UE 302 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an Internet of Things (IoT) device, or a similar type of device.

The network device 104 may include one or more devices capable of receiving, processing, storing, routing, and/or providing information associated with sharing services across UEs, as described elsewhere herein. The network device 104 may be an aggregated network node, meaning that the aggregated network node is configured to utilize a radio protocol stack that is physically or logically integrated within a single RAN node (e.g., within a single device or unit). The network device 104 may be a disaggregated network node (sometimes referred to as a disaggregated base station), meaning that the network device 104 is configured to utilize a protocol stack that is physically or logically distributed among two or more nodes (such as one or more central units (CUs), one or more distributed units (DUs), or one or more radio units (RUs)). The network device 104 may include, for example, a New Radio (NR) base station, a Long-Term Evolution (LTE) base station, a Node B, an eNB, a gNodeB, an access point, a transmission reception point (TRP), a DU, an RU, a CU, a mobility element of a network, a core network node, a network element, a network equipment, and/or a RAN node. The network device 104 may include a base station in a RAN, an AMF, an AUSF, a UDM, an AAnF, an NEF, an AF, a contacts manager, and/or a profile manager such as a SIM profile manager.

The content server 108 may include one or more devices capable of receiving, generating, storing, processing, providing, and/or routing information associated with sharing services across UEs, as described elsewhere herein. The content server 108 may include a communication device and/or a computing device. For example, the content server 108 may include a content server, an application server, a client server, a web server, a database server, a host server, a proxy server, a virtual server (e.g., executing on computing hardware), or a server in a cloud computing system. In some implementations, the content server 108 may include computing hardware used in a cloud computing environment, such as one or more serverless components (e.g., one or more serverless functions).

The network 304 may include one or more wired and/or wireless networks. The network 304 may include a terrestrial network. For example, the network 304 may include a cellular network (e.g., a Fifth Generation (5G) network, a Fourth Generation (4G) network, an LTE network, a Third Generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 304 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

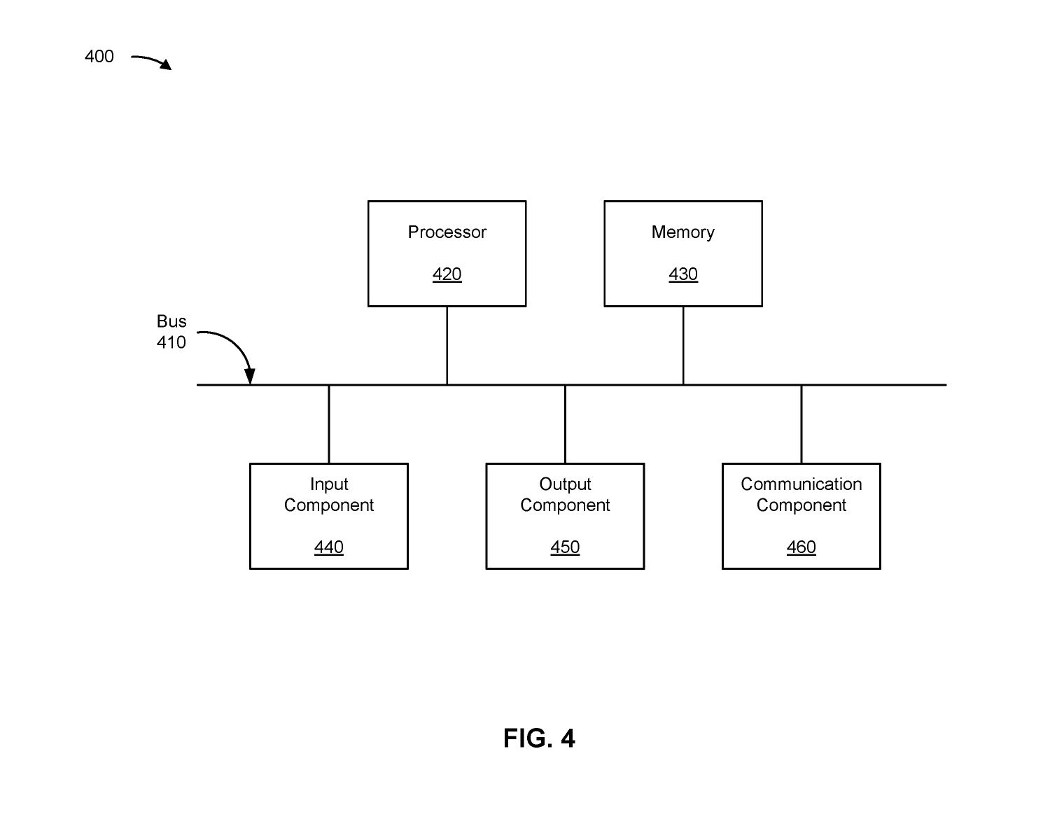

FIG. 4 is a diagram of example components of a device 400 associated with sharing services across UEs. The device 400 may correspond to a device (e.g., device 104). In some implementations, the device may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

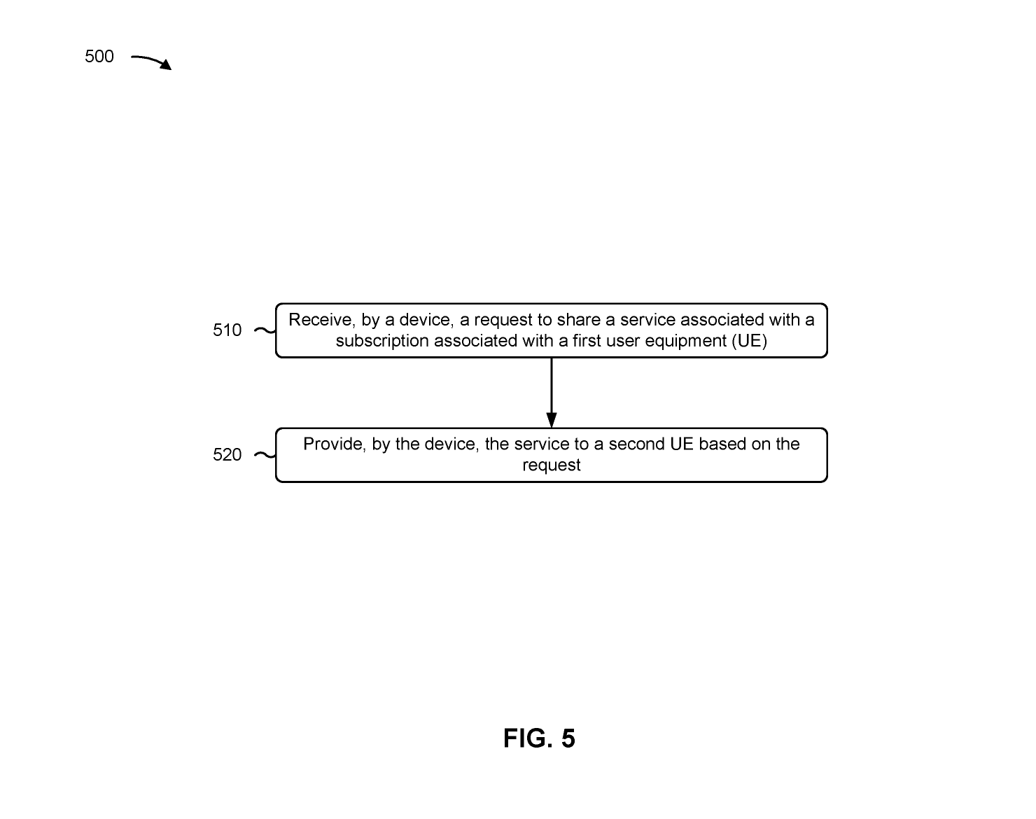

FIG. 5 is a flowchart of an example process 500 associated with sharing services across UEs. In some implementations, one or more process blocks of FIG. 5 may be performed by a device (e.g., device 104). In some implementations, one or more process blocks of FIG. 5 may be performed by another device or a group of devices separate from or including the device. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, by the device, a request to share a service associated with a subscription (block 510). The subscription may be associated with a first UE. The request may be for the service to be shared with a second UE that is not associated with the subscription. The device may maintain a contact list associated with the first UE. A contact associated with the second UE may be indicated in the contact list. The service may be shared with the contact based on an inclusion of the contact on the contact list. The first UE and the second UE may be associated with a same service provider, or alternatively, the UE and the second UE may be associated with different service providers. The service may be a content delivery service (e.g., a video streaming service or a gaming service). The service associated with the subscription may be one of a plurality of services associated with the subscription, where at least one service of the plurality of services is not shared with the second UE.

As shown in FIG. 5, process 500 may include providing, by the device, the service to the second UE based on the request (block 520). In some implementations, the device may identify a primary key associated with the subscription. The device may generate, in response to the request, a secondary key based on the primary key, where the secondary key may be associated with a limited functionality in relation to the primary key. The device may store the primary key and the secondary key. The device may provide the secondary key to the second UE, where access to the service may be based on the secondary key. In some implementations, the device may receive a request to access the service associated with the subscription, where the request to access the service may indicate the secondary key. The device may perform a verification that the secondary key indicated in the request to access the service corresponds to the secondary key that was generated based on the primary key. The device may grant the second UE access to the service based on the verification. In some implementations, the device may create, in response to the request, a profile for the second UE, where the profile may indicate that the second UE is allowed to access the service. The device may provide the profile to the second UE, where access to the service may be based on the profile.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to share a service associated with a subscription, wherein the subscription is associated with a first user equipment (UE), and the request is for the service to be shared with a second UE that is not associated with the subscription; and
providing, by the device, the service to the second UE based on the request.

2. The method of claim 1, further comprising:
maintaining, by the device, a contact list associated with the first UE, wherein a contact associated with the second UE is indicated in the contact list, and wherein the service is shared with the contact based on an inclusion of the contact on the contact list.

3. The method of claim 1, further comprising:
identifying, by the device, a primary key associated with the subscription;
generating, by the device and in response to the request, a secondary key based on the primary key, wherein the secondary key is associated with a limited functionality in relation to the primary key;
storing, by the device, the primary key and the secondary key; and
providing, by the device, the secondary key to the second UE, wherein access to the service is based on the secondary key.

4. The method of claim 3, further comprising:
receiving, by the device, a request to access the service associated with the subscription, wherein the request to access the service indicates the secondary key;
performing, by the device, a verification that the secondary key indicated in the request to access the service corresponds to the secondary key that was generated based on the primary key; and
granting, by the device, the second UE access to the service based on the verification.

5. The method of claim 1, further comprising:
creating, by the device and in response to the request, a profile for the second UE, wherein the profile indicates that the second UE is allowed to access the service; and
providing, by the device, the profile to the second UE, wherein access to the service is based on the profile.

6. The method of claim 1, wherein the service associated with the subscription is one of a plurality of services associated with the subscription, and wherein at least one service of the plurality of services is not shared with the second UE.

7. The method of claim 1, wherein the first UE and the second UE are associated with a same service provider.

8. The method of claim 1, wherein the first UE and the second UE are associated with different service providers.

9. The method of claim 1, wherein the service is a content delivery service.

10. A device, comprising:
one or more processors configured to:
receive a request to share a service associated with a subscription, wherein the subscription is associated with a first user equipment (UE), and the request is for the service to be shared with a second UE that is not associated with the subscription; and
provide the service to the second UE based on the request.

11. The device of claim 10, wherein the one or more processors are further configured to:
maintain a contact list associated with the first UE, wherein a contact associated with the second UE is indicated in the contact list, and wherein the service is shared with the contact based on an inclusion of the contact on the contact list.

12. The device of claim 10, wherein the one or more processors are further configured to:
identify a primary key associated with the subscription;
generate, in response to the request, a secondary key based on the primary key, wherein the secondary key is associated with a limited functionality in relation to the primary key;
store the primary key and the secondary key; and
provide the secondary key to the second UE, wherein access to the service is based on the secondary key.

13. The device of claim 12, wherein the one or more processors are further configured to:
receive a request to access the service associated with the subscription, wherein the request to access the service indicates the secondary key;
perform a verification that the secondary key indicated in the request to access the service corresponds to the secondary key that was generated based on the primary key; and
grant the second UE access to the service based on the verification.

14. The device of claim 10, wherein the one or more processors are further configured to:
create, in response to the request, a profile for the second UE, wherein the profile indicates that the second UE is allowed to access the service; and
provide the profile to the second UE, wherein access to the service is based on the profile.

15. The device of claim 10, wherein the service associated with the subscription is one of a plurality of services associated with the subscription, and wherein at least one service of the plurality of services is not shared with the second UE.

16. A non-transitory computer-readable medium storing a set of instructions, the set of instructions comprising:
one or more instructions that, when executed by one or more processors of a device, cause the device to:
receive a request to share a service associated with a subscription, wherein the subscription is associated with a first user equipment (UE), and the request is for the service to be shared with a second UE that is not associated with the subscription; and
provide the service to the second UE based on the request.

17. The non-transitory computer-readable medium of claim 16, wherein the one or more instructions, when executed by the one or more processors of the device, cause the device to:
maintain a contact list associated with the first UE, wherein a contact associated with the second UE is indicated in the contact list, and wherein the service is shared with the contact based on an inclusion of the contact on the contact list.

18. The non-transitory computer-readable medium of claim 16, wherein the one or more instructions, when executed by the one or more processors of the device, cause the device to:
identify a primary key associated with the subscription;
generate, in response to the request, a secondary key based on the primary key, wherein the secondary key is associated with a limited functionality in relation to the primary key;
store the primary key and the secondary key; and
provide the secondary key to the second UE, wherein access to the service is based on the secondary key.

19. The non-transitory computer-readable medium of claim 18, wherein the one or more instructions, when executed by the one or more processors of the device, cause the device to:
receive a request to access the service associated with the subscription, wherein the request to access the service indicates the secondary key;
perform a verification that the secondary key indicated in the request to access the service corresponds to the secondary key that was generated based on the primary key; and
grant the second UE access to the service based on the verification.

20. The non-transitory computer-readable medium of claim 16, wherein the one or more instructions, when executed by the one or more processors of the device, cause the device to:
create, in response to the request, a profile for the second UE, wherein the profile indicates that the second UE is allowed to access the service; and
provide the profile to the second UE, wherein access to the service is based on the profile.
